(19) United States
(12) Patent Application Publication
(10) Pub. No.: US 2013/0198040 A1
(43) Pub. Date: Aug. 1, 2013

(54) METHOD FOR AUTOMATICALLY CREATING NEW LISTING NOTIFICATIONS

(71) Applicant: DELTA MEDIA GROUP, INC., Canton, OH (US)

(72) Inventor: MICHAEL MINARD, MASSILLON, OH (US)

(73) Assignee: DELTA MEDIA GROUP, INC., CANTON, OH (US)

(21) Appl. No.: 13/757,131

(22) Filed: Feb. 1, 2013

Related U.S. Application Data
(60) Provisional application No. 61/593,594, filed on Feb. 1, 2012.

(51) Int. Cl. G06Q 30/06; G06Q 50/16

(52) U.S. Cl. CPC G06Q 30/0623; G06Q 50/16
USPC 705/26.61; 705/26.7

(57) ABSTRACT

A method for notifying a user about new property listings includes: determining, when the user connects to a real estate property portal of a notification system that also includes a real estate property listing database, whether the user previously connected to the portal; retrieving activity of the user from previous connections of the user to the portal if the user previously connected to the portal; tracking and saving the activity of the user while the user is connected to the portal; and analyzing for patterns in the tracked and/or retrieved activity of the user; wherein the notification system is programmed to perform such steps. The portal is programmed to retrieve listings from the real estate property listing database.

This application claims priority to U.S. Provisional Patent Application No. 61/593,594, entitled AUTO-GENERATED PROPERTY E-MAIL NOTIFICATION SYSTEM, filed Feb. 1, 2012, which is incorporated herein by reference.

### I. BACKGROUND

A. Field

This invention relates generally to computers and computer software, and more specifically to the provision of real estate listing services to users by an electronic communications medium.

B. Description of the Related Art

In the residential segment of the real estate industry, computerized real estate information databases, known as multiple listing service (MLS) databases, have become an indispensable source of centralized real estate property listing information. MLS databases enjoy widespread acceptance throughout the industry. Individual real estate agencies subscribe to the MLS and provide information about properties both listed and sold. But access is ordinarily restricted to licensed real estate professionals, appraisers, and lending institutions.

In recent years, however, various real estate agencies and brokers have begun offering real estate listing information to prospective buyers as a service, via access to portals on the real estate agency's website. Typically, the MLS-style databases offered to prospective buyers by real estate agents contain a set of property listing records describing real estate properties being offered for sale, leasing, or rental for a defined geographic region. Listings may include maps and photographs of the property, size and amenity details, and/or mortgage rate, pricing and tax information, including the price and terms at which a particular property sold. Each listing identifies and describes the various characteristics of the property in a standard, pre-defined format, which can be easily and accurately searched.

Unfortunately, real estate agencies encounter substantial difficulties in providing prospective buyers with access to new or updated listing information. Therefore, what is needed is a computer system and software program that automatically provides prospective buyers with relevant information about new or updated real estate listing information based on identified preferences or past search parameters.

### II. SUMMARY

According to one aspect, a method for notifying a user about new property listings includes a) providing: a user client; a communication interface; and a notification system including a real estate property portal and a real estate property listing database; wherein the user client is programmed to connect to the real estate property portal through the communication interface; wherein the real estate property portal is programmed to retrieve listings from the real estate property listing database; and wherein the user uses the user client to connect to the portal to view or search for the listings; b) determining, when the user connects to the portal using the user client, whether the user previously connected to the portal; c) retrieving activity of the user from previous connections of the user to the portal if the user previously connected to the portal; d) tracking and saving the activity of the user while the user is connected to the portal; and e) analyzing for patterns in the tracked and/or retrieved activity of the user; wherein the notification system is programmed to perform steps b)-e).

According to another aspect, a real estate property notification system includes: a real estate property portal; and a real estate property listing database; wherein the real estate property portal can be connected to by an associated user client through an associated communication interface; wherein the real estate property portal is programmed to retrieve listings from the real estate property listing database; wherein the notification system is programmed to: determine whether a user who connects to the portal using the associated user client has previously connected to the portal; retrieve activity of the user from previous connections of the user to the portal if the user previously connected to the portal; track and save the activity of the user while the user is connected to the portal; analyze the tracked activity of the user for patterns; prompt the user for contact information if the user did not previously provide contact information and if the analysis indicated at least one pattern; and automatically send notification of new listings in the database that match the analyzed patterns if the analysis indicates at least one pattern and if the user provided contact information.

One advantage is that, upon registration with a real estate property computer system, whenever a newly-listed property matching certain real estate property preferences is identified, the prospective buyer may be automatically notified. This real-time notification system keeps prospective buyers informed of changes in the availability of real estate listings.

Still other benefits and advantages will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a diagram of a notification system communicating with a user client;

FIG. 2 is a diagram of the notification system hardware;

FIG. 3 is a diagram of the notification system; and,

FIG. 4 is a flow chart for a notification process implemented by the notification system.

### IV. DEFINITIONS

The following terms may be used throughout the descriptions presented herein and should generally be given the following meaning unless contradicted or elaborated upon by other descriptions set forth herein.

Communication interface—an electric, electronic, or electromagnetic circuit that enables one computer to telecommunicate with another computer.

Database caching server cluster—multiple computers working together so that they can be viewed as one system, used for storing data from at least one database server cluster for future requests from the web server cluster.

Database load balancer—a device that distributes workload across at least one database server cluster for optimal resource utilization and/or better reliability.

Database server cluster—multiple computers working together so that they can be viewed as one system, used for storing real estate data.

Pattern—real estate property criteria that a user triggers exactly or within a specified percentage at least a specified number of times while connected to a real estate property portal.

Portal—a website that acts as an entry point to a real estate property database.

User client—any general-purpose or special-purpose computer or a telephone that a user may use to access the notification system.

Web server cluster—multiple computers working together so that they can be viewed as one system, used to store and execute software that can be accessed through the Internet.

Web server load balancer—a device that distributes workload across the web server cluster for optimal resource utilization and/or better reliability.

### V. DETAILED DESCRIPTION

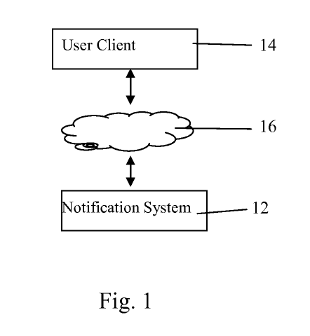

Referring now to the drawings wherein the showings are for purposes of illustrating embodiments of the invention only and not for purposes of limiting the same, and wherein like reference numerals are understood to refer to like components, FIG. 1 shows a diagram of a notification system 12 communicating with a user client 14 through a communication interface 16. The user client 14 may be a personal computer, a personal digital assistant, a mobile device, or any other general-purpose or special-purpose computer that a user 10 can use to access the notification system 12. In an alternative embodiment, the notification system 12 may be programmed for Interactive Voice Response, and the user 10 may access the notification system 12 through a telephone and may interact with the notification system 12 by voice commands.

The communication interface 16 may be wired or wireless. The interface 16 may be via a global computer network. The interface 16 may use the HTTP protocol. The communication interface 16 between the user client 14 and notification system 12 may include any method known to one of ordinary skill in the art, including, but not limited to, LAN, Ethernet, USB, Firewire, WiFi, Bluetooth, RF, CDMA, TDMA, GSM, or infrared. A user 10 may use the user client 14 to access, through the communication interface 16, the notification system 12. The notification system 12 may transmit communications, through the communication interface 16, to the user client 14, as further described below, for the user 10 to view.

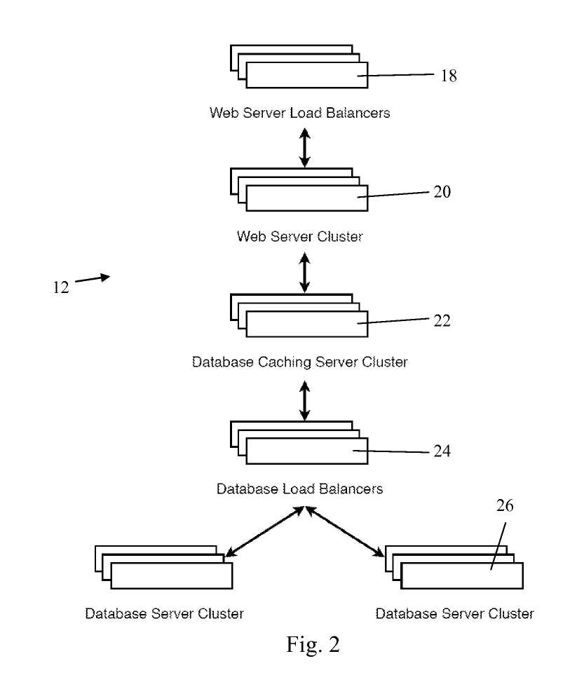

FIG. 2 shows a diagram of the notification system 12 hardware. The notification system 12, in an alternative embodiment, may include several hardware units, including, but not limited to, web server load balancers 18, a web server cluster 20, a database caching server cluster 22, database load balancers 24, and database server clusters 26. The web server load balancers 18 and the database load balancers 24 may distribute the workload of the system 12 across multiple computers or a cluster 20, 26 for optimal resource utilization and/or better reliability. The web server cluster 20 and database server clusters 26 may include multiple computers working together so that they can be viewed as one system. The software application implementing the methods of this invention may be stored on and executed by the web server cluster 20. The database server clusters 26 may store all of the real estate data as further described below. The database caching server cluster 22 may act as an interface between the database server clusters 26 and the web server cluster 20. The database caching server cluster 22 may have smaller storage capacity than the database server clusters 26 but have a faster communication speed to the web server cluster 20 than the database server clusters 26 have to the web server cluster 20. The database caching server cluster 22 may cache, or store for future requests, data from the database server clusters 26, thus helping achieve high scalability and performance. In an alternative embodiment, the application and database 32 may be included on one server.

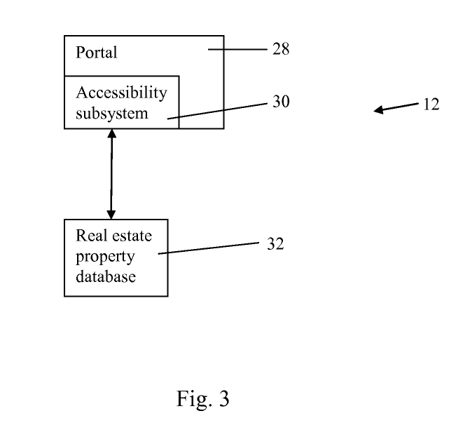

FIG. 3 shows a diagram of the notification system 12. According to one embodiment, an MLS database or other such real estate property database 32 as is known in the art, may be accessible to the user 10 through the notification system 12. The MLS database 32 may be stored on the database server clusters 26. The MLS database 32 may communicate with a networked real estate property portal 28 that communicates with real estate agents/brokers and prospective real estate buyers and sellers, via one or more networks 16. The property portal 28 may be implemented by the web server cluster 20. The notification system 12 may also include databases containing information on user contact and preference information, and search histories. This database may be stored on the database server clusters 26 or on the web server cluster 20. The communication between the user client 14 and the portal 28 may be either secure (e.g., virtual private network) or less secure as provided by most websites. In an alternative embodiment, the real estate property portal 28 may be accessed by the user client 14 through another system or web service, such as, but not limited to, FACEBOOK® and Google+.

The communication interface 16 may communicate with an accessibility subsystem 30 for determining the access level to be provided to users 10 requesting access. At least the following types of users 10 may be distinguished by this subsystem: (i) agents/brokers 10 registered to use the services of the portal 28 (Realtors®, etc.), (ii) potential real estate buyers or sellers 10 registered to use the services of the portal 28, and (iii) non-registered users 10. As a practical matter, non-registered users 10 may have access to some website content; however, a simple registration process is strongly incentivized by offering users 10 greater access to website content.

In one embodiment, the accessibility subsystem 30 may register users 10 to allow greater access to the portal's services. The registration process may require the user 10 to provide certain baseline information, such as name, e-mail address, and phone number, all of which may be stored for later use and analysis on web servers or other storage mediums as is known in the art. The entry of user information, from the user client 14, or other networked device, into the portal's accessibility subsystem 30 (or other such information interface) may be accomplished using any process known to those skilled in the art. In addition to baseline information, users 10 may also optionally provide input preference information on real estate characteristics, such as, by way of non-limiting example, the purpose or reason for the purchase, characteristics of a desired transaction, characteristics of an acceptable neighborhood, and characteristics of an acceptable home. Input preference information may be inputted in a detailed fashion on each of these topics. For example, a user 10 may specify the purpose of the purchase: such as, at least, a primary residence, rental, speculation, rebuild/renovation, or buyer for another person. Input preference information on the reason for the purchase may be input to specify that, for example, the user 10 needs more room, needs less room, wants to be closer to work, wants to live in a nicer neighborhood or school system, or is relocating for a job. Users 10 could also optionally describe the desirable characteristics of their potential purchase transaction; including, at least, the types of mortgages acceptable, the amount available for a down payment, acceptable monthly payment ranges, and purchase options such as lease to buy. Users 10 could also input preference information about a desirable neighborhood, such as, by way of non-limiting examples, “quiet” or “energetic,” covenant obligations and amenities, low crime rate, distance to freeway or shopping, average property price, and accessibility to recreational activities such as parks and/or hiking or biking paths. And users 10 may add input preference information on the property itself: private residence, commercial, raw land, distressed property; size characteristics such as square feet ranges, number of bedrooms, parking facilities; and anticipated maintenance costs.

Once registered, users 10 may query the MLS database or other such real estate property database 32 via the real estate property website portal 28 to locate real estate properties meeting their selected criteria. Users 10 may save their search results, particularly those real estate properties of interest, for later review. Search results, saved searches, and other user information may be stored for later use on various storage mediums as is known in the art.

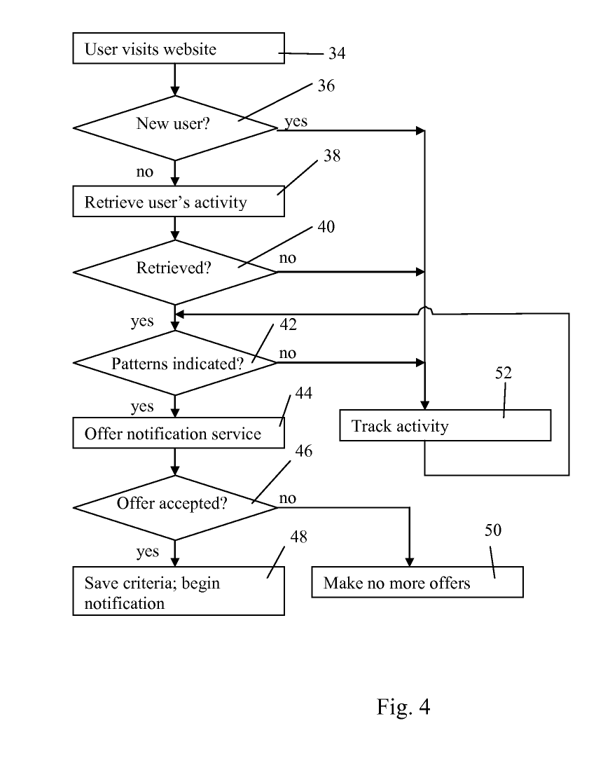

FIG. 4 shows a flow chart for a notification process implemented by the notification system 12. At block 34, the user 10 may visit the website or portal 28 of the system 12. At block 36, the system 12 may determine whether the user 10 is new or whether the user 10 has previously visited the portal 28. The system 12 may determine whether the user 10 is new or not by checking cookies stored on the user client 14 or by asking the user 10 to log in or create a new account when the user 10 first visits the portal 28. If the user 10 is new, at block 52, the system 12 may begin tracking the user's activity. Such activity may include: searching for properties for sale, rent, or lease; viewing detailed property listings; saving property searches; saving properties; requesting a showing on a property; or asking questions on properties. Such tracking may include saving, whether on the user client 14 by cookies or other known structures or on a remote database, searches that the user 10 initiated or listings that the user 10 viewed. The system 12 could also prompt a new user 10 to enter identification information at block 52 so the system 12 may remember the user 10 on future visits to the portal 28. In an alternative embodiment, a user 10 may opt during the registration process to receive new listing notification e-mails, which automatically disclose information to the user 10 on new real estate property listings added to the MLS database 32 based on input preference information and other information, as they become available after the user's search session. If the user 10 is not new, at block 40, the system 12 may attempt to retrieve previous activity of the user 10 as stored by the system 12.

At block 40, the system 12 may determine whether it was successful in retrieving a previous user's activity. If the system 12 was not successful, it may begin tracking the user's activity, just as discussed with respect to block 52. If the system 12 was successful, it may analyze the retrieved user activity for patterns in interest at block 42. The analysis may include the following criteria: location, price, style, features, number of bedrooms, number of bathrooms, number of garage spaces, property size, land size, and sale type of properties viewed by the user 10. If a new user 10 performs at least one property search, the system 12 may use at least one of the search criteria as the pattern initially. If a user 10 has previously used the system 12, the system 12 may analyze whether the user 10 has performed at least a certain number of searches, for example three, that have criteria that is the same or within a certain variance percentage, for example 2%, 15%, or 20%. If such repeated criteria is found, that criteria may be used as the pattern.

If a user 10 views in detail a property listing, the system 12 may use the criteria of that listing in analyzing for patterns. Each of the various criteria may be assigned a varying weight or importance. For example, viewing the same property multiple times may increase the importance of criteria triggered by or assigned to that property. For another example, if the user 10 views properties that are condos or lake-front, the system 12 may infer that the user 10 may be interested in condos or lake-front properties, respectively, and use the condo or lake-front criteria as the pattern.

Even if the system 12 was successful in retrieving a previous user's activity, the system 12 may still track the user's activity as described with respect to block 52 and associate this current activity with the user's previous retrieved activity. If the analyzed activity does not indicate a pattern in block 42, the system 12 may continue tracking activity of the user 10 at block 52 for future analysis. The system 12 may continue looping through blocks 52 and 42 every time a new user 10 visits the portal 28, when the system 12 cannot retrieve a previous user's tracked activity, or when the retrieved activity of a previous user 10 does not indicate any patterns after analysis at block 42.

If the tracked activity does indicate any patterns in interest, at block 44, the system 12 may offer to send the user 10 notification about new listings that match the patterns derived from the analyzed user activity. The notification may include new listings that match exactly the criteria of the patterns or that are within a certain percentage, for example 15% or 20%, of the patterns. The analysis may be performed quietly in the background without interfering with the user's searching until a pattern is inferred, at which point the system 12 may make the offer of block 44. Alternatively, the system 12 may make the offer of block 44 at the user's next visit to the portal 28 instead of during the current visit. Alternatively, the system 12 may omit blocks 44 and 46 and immediately start e-mailing the user 10 new listings that match the user's patterns. In another embodiment, the system 12 may omit blocks 44 and 46 and start e-mailing the user 10 new listings that match the user's patterns after some future point in time, such as scheduled post-data processing. In an alternative embodiment, the system 12 may notify a real estate agent or company working with the user 10 that the system 12 has detected patterns in the user's activity so the agent or company may contact the user 10 with further assistance.

At block 46, the system 12 may determine whether the user 10 accepted such an offer (if the offer was made in block 44). If the user 10 did not accept the offer, at block 50, the system may make no further offers to the user 10 during this visit to the portal 28, but the system 12 may continue tracking and saving that user's activity during that visit and offer the notification service of block 44 during the user's next visit to the portal 28.

In another embodiment, where the user 10 elected either to not enter input preference information and/or receive new listing notification e-mails, the system 12 may review recent search criteria selected by the user 10 to identify a range of search parameters and identify patterns in search activities. The system 12 may then analyze these recent search criteria to identify search preference information. Said search preference information might consist of, by way of non-limiting example, preference information derived from the criteria a user 10 has input to conduct a real estate properties search, which real estate properties were saved for later review, and the search results provided. Specifically, search preference information may typically include, at least, preferences derived from location, price, and acceptable home characteristics (size, amenities, etc.) criteria entered in user searches.

If the user 10 did accept the offer, at block 48, the system 12 may record the criteria for which the offer was made, and the system 12 may begin e-mailing information to the user 10. Such e-mailing may be daily, weekly, monthly, or at any other periodic interval. In an alternative embodiment, such e-mailing may also be triggered by certain events rather than being periodic. The minimum information that the system 12 needs the user 10 to enter before e-mailing new listings matching the analyzed patterns is an e-mail address of the user 10. If the system 12 does not have an e-mail address of the user 10 whose analyzed activity indicates a patter, the system 12 may ask the user 10 for the user's e-mail address.

New listing notification e-mails may be generated by a computer software program in communication with the MLS database 32 and real estate property portal 28. In one embodiment, input preference information inserted by the user 10 during the registration process may be compared against real estate property characteristics contained in the MLS database 32, and if real estate properties matching (within an acceptable range of similarity as selected by either the user 10 or the system 12) the input preference information are identified, then a new listing notification e-mail may be sent by the real estate property portal 28 to the user 10 relating information about potentially desirable real estate properties. In some embodiments, the new listing notification e-mail may optionally include, or be substituted by, a text message, telephone message, or any other type of electronic message as is known in the art, notifying the user 10 of a potentially desirable real estate property. In an alternative embodiment, the system 12 does not require the user 10 to enter search criteria, but may rather determine relevant criteria from analyzing patterns in the user's search activity.

In an alternative embodiment, the notification system 12 compares search preference information against real estate property characteristics contained in the MLS database 32, and if real estate properties matching (within an acceptable range of similarity as selected by the system 12) the search preference information are identified, then a new listing notification e-mail may be created. In some embodiments, users 10 not specifically electing to receive new listing notification e-mails may be contacted, via contact information inputted during the registration process, and notified that a new listing notification e-mail has been created based on their search preference information. In some embodiments, the new listing notification e-mail, and the potentially desirable real estate properties identified therein, may be sent directly to the user 10. In still other embodiments, users 10 may be notified when they next access the real estate property portal 28 that a new listing notification e-mail has been created based on their search preference information. In one embodiment, a user 10 may access the MLS database 32 without registration, so long as sufficient user information is extracted from the user's search session to enable the real estate agency to contact the user 10 after the end of the search session for the purpose of providing a new listing notification e-mail derived from an analysis of search preference information.

In still other embodiments, the notification system 12 may compare both input preference information and search preference information against real estate property characteristics contained in the MLS database 32, and if real estate properties matching (within an acceptable range of similarity as selected by either the user 10 and/or the system 12) either the input preference information or search preference information are identified, then a new listing notification e-mail may be sent by the real estate property portal 28 to the user 10 relating information about potentially desirable real estate properties.

In some embodiments, a new listing notification e-mail may be only sent to the user 10 if the notification system 12 determines that a potentially desirable property has not been previously viewed by the user 10 in the course of the user search sessions. In other embodiments, all forms of preference information may be periodically and recurrently compared against newly updated real estate property characteristics contained in the MLS database 32 to determine if a new listing notification e-mail may be warranted and should be sent. In one embodiment, the system 12 conducts periodic scheduled reviews of the information contained in the MLS database 32 to identify new potentially-desirable real estate properties based on all forms of preference information. In other embodiments, the system 12 screens new listing information sent by the MLS database 32 to the real estate property portal 28 to identify potentially-desirable real estate properties.

In an alternative embodiment, the notification system 12 first reviews the real estate computer network system (specifically, the MLS database 32 and real estate property portal 28) to identify users 10 who have either entered input preference information and/or opted to receive new listing notification e-mails, and those who have not. For users 10 who have not selected the option of receiving a new listing notification e-mail, the system 12 may query the relevant databases to identify the recent user activities with respect to search criteria, real estate properties viewed, and real estate properties saved. If the system 12 detects a pattern with respect to any real estate property search preferences—such, for example, regarding location, price, or property criteria—then the system 12 creates search preference information parameters, and a new listing notification e-mail may be generated to disclose any newly added (i.e., added or amended since the user's last search session) MLS properties that the system 12 characterizes as potentially desirable real estate properties. The user 10 may be subsequently notified that a new listing notification e-mail, containing potentially desirable real estate properties, has been created, and is available for user review. Optionally, a Realtor® may be notified every time a client 10 or prospective buyer 10 is provided with a new listing notification e-mail.

In an alternative embodiment, the notification system 12 may additionally identify the necessity of providing new listing notification e-mails disclosing new properties to those users 10 who entered input preference information and/or opted to receive new listing notification e-mails. First, the system 12 may review user input preference information or other information entered into the system in the process of signing up for new listing notification e-mails to identify baseline real estate property preferences. Then, the system 12 may query the relevant databases to identify search preference information based on the user's recent activities with respect to search criteria, real estate properties viewed, and real estate properties saved. If the system 12 determines that the user's input preference information and search preference information are the same, then no new listing notification e-mail is generated. If, however, the system 12 detects that the user's search preference information—such as, for example, regarding location, price, or property criteria—is different than the input preference information, then a new listing notification e-mail may be generated to disclose any newly added (i.e., added or amended since the user's last search session) MLS properties that the system 12 characterizes as potentially-desirable real estate properties based on the changes identified in search preference information.

In an alternative embodiment, the notification system 12 may perform auditing of the data representing the tracked activity of the user 10. Such auditing may be necessary for at least the following reasons: first, the system 12 may not be able to process and analyze past activity and current activity of a user 10 in real time while the user 10 is visiting the portal 28 due to server load; second, the system 12 may not have sufficient data to detect a pattern at the time of the user's current visit to the portal 28; however, after the user's visit has concluded, sufficient data may have been collected to detect a pattern.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A method for notifying an associated user about new property listings comprising the steps of:
a) providing:
a user client;
a communication interface; and
a notification system comprising:
a real estate property portal; and
a real estate property listing database;
wherein the user client is programmed to connect to the real estate property portal through the communication interface;
wherein the real estate property portal is programmed to retrieve listings from the real estate property listing database; and
wherein the user uses the user client to connect to the portal to view or search for the listings;
b) determining, when the user connects to the portal using the user client, whether the user previously connected to the portal;
c) retrieving activity of the user from previous connections of the user to the portal if the user previously connected to the portal;
d) tracking and saving the activity of the user while the user is connected to the portal; and,
e) analyzing for patterns in the tracked and/or retrieved activity of the user;
wherein the notification system is programmed to perform steps b)-e).

2. The method of claim 1 further comprising the steps of:
f) prompting the user for contact information if the user did not previously provide contact information; and,
g) sending to the user notification of new listings in the database that match the analyzed patterns if the analysis indicated at least one pattern and if the user provided contact information, wherein step f) occurs after step b) when the user connects to the portal or after step e) and before step g) if the analysis indicated at least one pattern, wherein step g) occurs after step e), and wherein the notification system is further programmed to perform steps f) and g).

3. The method of claim 2 further comprising the step of:
h) offering to notify the user of new listings that match the analyzed patterns if the analysis indicated at least one pattern, wherein step h) occurs after step e) and before step g), wherein step g) occurs only if the user accepts the offer of step h), and wherein the notification system is further programmed to perform step h).

4. The method of claim 3 wherein activity of the user is at least one of the group comprising: search criteria selected by the user, search criteria saved by the user, criteria of listings about which the user submitted questions, criteria of listings for which the user requested a showing, criteria of listings saved by the user, and criteria of listings viewed in detail by the user.

5. The method of claim 4 wherein the pattern analysis of step e) analyzes for patterns in at least one of the group comprising: property location, crime rate, distance to freeway, distance to shopping, distance to schools, distance to parks, anticipated maintenance costs, property price, property style, property features, amenities, number of bedrooms, number of bathrooms, property size, land size, covenant obligations, sale type, and garage space.

6. The method of claim 5 wherein if the notification system does not have free resources to complete the analysis of step e) while the user is connected to the portal, the analysis of step e) is performed at a later time when resources become available.

7. The method of claim 6 further comprising the step of:
i) allowing the user to enter desired property listing criteria, wherein step i) occurs after step c), wherein the sending of notification of step g) also includes sending notification of new listings that match the desired property listing criteria as entered by the user, wherein the notification system is further programmed to perform step i).

8. The method of claim 7 further comprising the step of:
j) notifying a real estate agent via the notification system if the analysis indicated at least one pattern and if the user provided contact information, wherein step j) occurs after step h), and wherein the notification system is further programmed to perform step j).

9. The method of claim 8 wherein the automatic sending of step g) occurs at at least one of the frequencies chosen from the group consisting of: not more than once per day, not more than once per week, not more than once per month, at periodic intervals as set by the user, non-periodically, when the user indicates the notification should be sent, and when a new listing matching the analyzed patterns of the user is entered into the database.

10. The method of claim 9 wherein the notification is sent by at least one of the group comprising: e-mail, text message, and telephone message.

11. The method of claim 10 wherein contact information comprises an e-mail address and wherein the notification is sent by e-mail.

12. The method of claim 11 wherein sending the notification of new listings comprises sending the new listings.

13. A real estate property notification system comprising:
a real estate property portal; and,
a real estate property listing database, wherein the real estate property portal can be accessed by an associated user client through an associated communication interface, wherein the real estate property portal is programmed to retrieve listings from the real estate property listing database, wherein the notification system is programmed to:
determine whether a user who accesses the portal using the associated user client has previously accessed the portal;
retrieve activity of the user from previous connections of the user to the portal if the user previously accessed the portal;
track and save the activity of the user while the user is connected to the portal;
analyze the tracked activity of the user for patterns;
prompt the user for contact information if the user did not previously provide contact information and if the analysis indicated at least one pattern; and,
automatically send notification of new listings in the database that match the analyzed patterns if the analysis indicates at least one pattern and if the user provided contact information.

14. The system of claim 13 wherein the notification system is further programmed to offer to notify the user of new listings that match the analyzed patterns if the analysis indicated at least one pattern, wherein the automatic sending of notification is executed only if the user accepts the offer.

15. The system of claim 14 wherein the associated user client comprises:
a personal computer; or
a mobile device chosen from the group comprising: a laptop computer, a personal digital assistant, a tablet computer, and a cellular phone.

16. The system of claim 15 wherein the real estate property listing database comprises a multiple listing service (MLS) database.

17. The system of claim 16 wherein the associated communication interface is a global computer network.

18. The system of claim 17 further comprising:
at least one web server load balancer;
at least one web server cluster;
at least one database caching server cluster;
at least one database load balancer; and,
at least one database server cluster.

19. The system of claim 18 wherein the at least one database server cluster comprises the real estate property listing database.

20. The system of claim 19 wherein the notification system is further programmed to notify a real estate agent if the analysis indicated at least one pattern and if the user provided contact information.

21. A non-transitory computer readable medium including instructions for notifying an associated user about new property listings, the computer readable medium comprising the steps of:
a) providing:
a user client;
a communication interface; and
a notification system comprising:
a real estate property portal; and
a real estate property listing database;
wherein the user client is programmed to connect to the real estate property portal through the communication interface;
wherein the real estate property portal is programmed to retrieve listings from the real estate property listing database; and
wherein the user uses the user client to connect to the portal to view or search for the listings;
b) determining, when the user connects to the portal using the user client, whether the user previously connected to the portal;
c) retrieving activity of the user from previous connections of the user to the portal if the user previously connected to the portal;
d) tracking and saving the activity of the user while the user is connected to the portal; and,
e) analyzing for patterns in the tracked and/or retrieved activity of the user;
wherein the notification system is programmed to perform steps b)-e).
